(19) United States
(12) Patent Application Publication
(10) Pub. No.: US 2024/0386321 A1
(43) Pub. Date: Nov. 21, 2024

(54) Multimodal Learning from Structured and Unstructured Data

(71) Applicant: Google LLC, Mountain View, CA (US)

(72) Inventors: Sayna Ebrahimi, Los Altos Hills, CA (US); Yihe Dong, New York, NY (US); Tomas Pfister, Redwood City, CA (US); Sercan Omer Arik, San Francisco, CA (US)

(21) Appl. No.: 18/639,519

(22) Filed: Apr. 18, 2024

Related U.S. Application Data
(60) Provisional application No. 63/467,120, filed on May 17, 2023.

(51) Int. Cl. G06N 20/00

(52) U.S. Cl. CPC G06N 20/00

(57) ABSTRACT

Aspects of the disclosure are directed to a multimodal processing system for processing both structured and un-structured data. Real-world data is not always consistent in form or content. The multimodal processing system includes model that can be trained to account for this characteristic of real-world data, by selectively masking data of different modalities during pretraining to learn outputs that are the same or comparable between the masked and un-masked inputs. The model is trained according to modality-specific masking objectives computed for each modality of data and joint modality similarity-based masking objectives for a joint representation of the data across all modalities. The system provides consistent and accurate input, even when input data may have substantial portions of data from different modalities missing. Cross-modal relationships in data are reinforced by the model as different portions of data are masked, contributing to an overall increase in model accuracy versus other approaches.

### CROSS-REFERENCE TO RELATED APPLICATIONS

This application claims the benefit under 35 U.S.C. § 119 (e) of the filing date of U.S. Patent Application No. US 63/467,120, for MULTIMODAL LEARNING FROM STRUCTURED AND UNSTRUCTURED DATA, which was filed on May 17, 2023, and which is incorporated here by reference.

### BACKGROUND

Multimodal data is data of multiple modalities. A modality can be text, image, video, audio, and so on. Multimodal data can include data components of text and image, video and audio, image and video, or other combinations. Data can also be categorized as structured data or un-structured data. Structured data follows a predetermined format or organization, such as tables with columns of data, or time-series data with data points at each of a number of pre-determined time intervals. Un-structured data can be natural language, video, images, audio, or in general any other type of data that is not organized according to a predetermined format or structure.

Multimodal machine learning includes families of techniques for modeling unstructured data, specifically vision, language, video, and audio modalities. However, different real-world applications demonstrate the coexistence of structured data, e.g., tabular data, time-series data, etc., alongside unstructured data, for example in the fields of advertisement conversion prediction and retail demand prediction. Thus, a significant number of real-world machine learning scenarios, initially centered around unstructured data, inevitably encompass relevant structured data.

As the number of modalities and heterogeneity of input data increases, so does the challenge in training a machine learning model to generalize across the various modalities of input that can be received. This issue is exacerbated in structured data, for example, as time-series data often exhibits non-stationary behavior, making it difficult to use in building generalizable models. Modalities of data missing from input, whether partially or completely, also affect model performance. This can be especially true when a model is trained on data exhibiting multiple modalities but then receives data for inference with fewer modalities than the ones encountered in the data for training.

### BRIEF SUMMARY

Aspects of the disclosure are directed to a multimodal processing system for processing both structured and un-structured data. The system can implement one or more multimodal machine learning models trained to perform a task with input data that may have different modalities of data partially or completely missing, as real-world data is not always consistent in form or content. The model can be trained to account for this characteristic of real-world data, by selectively masking data of different modalities during pretraining to learn outputs that are the same or comparable between the masked and un-masked inputs. The model is trained according to modality-specific masking objectives computed for each modality of data and joint modality similarity-based masking objectives for a joint representation of the data across all modalities. For the similarity-based masking objective, the model is incentivized to generate similar output between masked and un-masked input. Training the model in this way allows the model at inference to provide consistent and accurate input, even when input data may have substantial portions, e.g., 15% or more, of data from different modalities missing. Further, cross-modal relationships are reinforced by the model as different portions of data are masked, contributing to an overall increase in model accuracy versus approaches in which data is not masked and a similarity-based objective or loss is not used.

Other implementations of this aspect include corresponding computer systems, apparatus, and computer programs recorded on one or more computer storage devices, each configured to perform the actions of the methods. Aspects of the disclosure provide for methods and systems for pretraining a fine-tuning a multimodal model to process a variety of different combinations of multimodal input.

### BRIEF DESCRIPTION OF THE DRAWINGS

FIG. 1 is a block diagram of an example multimodal processing system processing different combinations of multimodal input data, according to aspects of the disclosure.

FIG. 2 is a block diagram of an example multimodal model architecture that can be implemented by the multimodal processing system, according to aspects of the disclosure.

FIG. 3A is a block diagram of a first portion of an example pipeline implemented by a model training engine for computing a masking multimodal loss for training a multimodal model, according to aspects of the disclosure.

FIG. 3B is a block diagram of a second portion of an example pipeline implemented by the model training engine for computing a multimodal masking loss for training a multimodal model, according to aspects of the disclosure.

FIG. 4 is a flow diagram of an example process for pretraining a multimodal model, according to aspects of the disclosure.

FIG. 5 is a flow diagram of an example process of processing input through a multimodal model pretrained, according to aspects of the disclosure.

FIG. 6 is a block diagram illustrating one or more models, such as for deployment in a datacenter housing one or more hardware accelerators on which the deployed models will execute for multimodal input processing, according to aspects of the disclosure.

FIG. 7 is a block diagram of an example computing environment for implementing the system, according to aspects of the disclosure.

### DETAILED DESCRIPTION

### Overview

Aspects of the disclosure provide for a multimodal processing system for processing and training machine learning models with different combinations of missing unstructured and structured data. A multimodal model trained as described herein learns a unified representation of both input structured and unstructured data through joint pretraining on all the available data, even with significant percentage of data, e.g., 15%, is missing from one or more modalities. The model is trained according to modality-specific masking losses, while learning cross-modal relationships through a similarity-based multimodal loss. This phase of model preparation, referred to herein as pretraining, is done on unlabeled data. The losses are combined as a total loss, which is used to pretrain the multimodal model, for example through backpropagation and gradient descent, with model weight update. Training the model can proceed to a fine-tuning stage, in which the multimodal model can be trained to perform a desired task, such as anomaly detection, product review prediction, and or any regression, classification, and/or retrieval task a model can be trained to perform. If trained using a supervised learning approach, the model can be fine-tuned on a fraction of labeled data, e.g., 0.01% of the total unlabeled data used during the pretraining stage.

The total loss used to pretrain a multimodal model is designed to incentivize the model generating output representations of input data that is similar as between masked and un-masked inputs. Not only does a model pretrained as described herein become more versatile to different input constraints, but the similarity-based objective described herein has been shown to improve the accuracy of model overall, at least because the masked data causes the model to identify new relationships between data components of different modalities in the input. In other words, because input data is not guaranteed to have structured and un-structured data of the same modalities and quantity or quality, the training process described herein causes the model to instead build these new relationships, encoded in the output encoded representations of the model after pretraining.

One bottleneck in multimodal data processing is extracting representations that reflect cross-modal interactions between data of different modalities. As the number of modalities grows, representation fusion increases in complexity, at least because input to process is often multi-dimensional and becomes more heterogeneous with more modalities represented. This increase in input data complexity can result in models that are more expensive to train and process and are less likely to be generalizable to performing other tasks, resulting in redundant computations to generate task-specific models.

These and other examples of combinations of structured and un-structured data are propelled by database management technologies improving data storage, integration, and manipulation at scale. In addition, the proliferation of multi-sensing technologies, such as wearable devices and specialized sensors in automobiles and manufacturing facilities, has resulted in the accumulation of high-dimensional time-series data and other structured data.

The multimodal model can handle various combinations of unstructured data, e.g., text, videos, images, audio, etc., as well as structured data, e.g., time series data and tabular data. Through a cross-modal training method described herein, multiple seemingly different data types can be learned by a model together, rather than separately, resulting in a fused representation that further allows a model to perform a downstream task, e.g., classification, regression, retrieval, etc., even when some or all data from one or more different modalities are missing. In some examples, the multimodal model when trained and deployed can achieve higher task accuracy even when, for example, anywhere from 15% to as much as 99.8% of data is missing or masked.

The training method described can extend to multiple modalities and is not limited to specific combinations of pairs or triplets of modalities as used in self-supervised multimodal learning approaches, such as instance discrimination-based approaches, matching-based approaches, and clustering-based approaches. In addition, the training methods described herein scales better for more training data over contrastive approaches requiring specific combinations of modalities. Better scaling leads to more efficient use of computing resources, e.g., processing cycles, memory bandwidth, and network transmission.

Further, the multimodal model presented herein avoids the computational expense in other approaches for handling structured data. For example, structured data is not converted to unstructured text for processing through a model trained for text and not structured data. As a result, paired table and text data for training is not needed. In addition, for multimodal datasets with a larger number of categorical features, concatenating or combining the features with language token sequences is often not possible, due to the token limit of the model receiving the data.

Furthermore, converting numerical data, e.g., as in time-series data, introduces potential translation or conversion issues if the numerical data is converted to text before sending to a model that does not natively support structured data. Training table-to-text generative models requires paired table and text data, while adding to the computational burden of preparing the training data over not converting tabular/time-series data to an unstructured format. By training a modality-specific encoder for structured data, the multimodal model described herein avoids these translation issues, bypassing the associated processing costs.

The model, once pretrained and fine-tuned, can be used in a variety of applications. As an example, the model can be trained to predict product reviews, e.g., out of five stars, for different products and services. Product data can be combinations of unstructured data, e.g., previous product reviews, text descriptions of a product, images or videos of the product, and structured dated, e.g., market study data or sales data over a period of time. In these examples and others, the same task may be performed even when the composition of input data varies, e.g., because some product data may have only descriptions and images of a product without any market study or sales data.

The pretraining foundation of the system allows for more efficient fine-tuning over other approaches that are subject to generalization issues. For example, the system achieves higher accuracy over other multimodal approaches, even when using a relatively small number of samples, e.g., 0.01% of the pretraining dataset size. Higher accuracy with fewer data results in less data needed for processing and storage in the long-term, and also makes the system adaptable to use cases, such as in retail prediction, in which fine-tuning data is often scarce and dissimilar. Further, pretraining can be done on unlabeled data, which is generally less time-consuming and cost-effective to obtain over its labeled data counter-parts.

### Example Systems

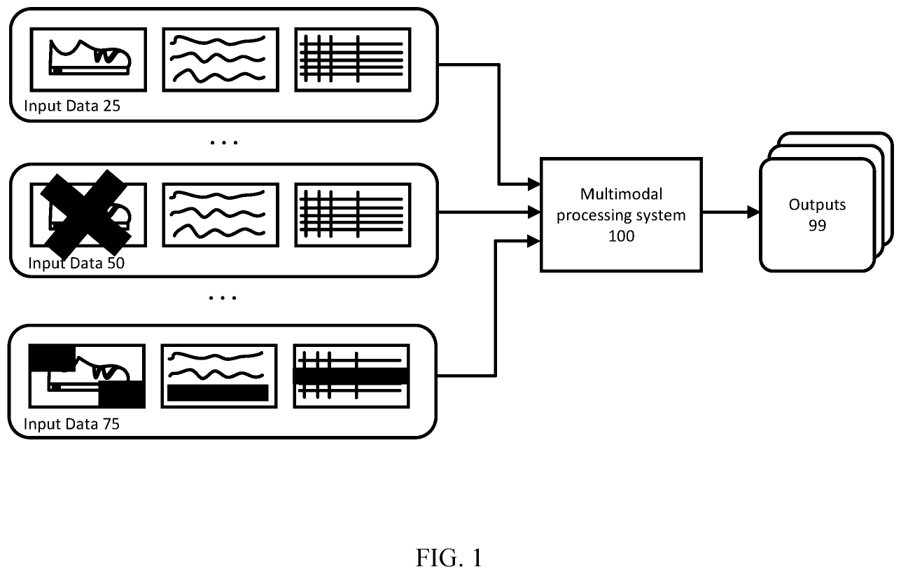

FIG. 1 is a block diagram of an example multimodal processing system 100 processing different combinations of multimodal input data, according to aspects of the disclosure. The multimodal processing system 100 can be implemented on one or more computing devices, e.g., as a personal computing device, mobile computing device, server, wearable device, such as a headset, glasses, smartwatch, etc., a video game console, etc. The system 100 receives various input data, such as input data 25, 50, 75. Input data can be received over a network or over another input/output interface implemented by computing devices that make up the system 100. The input data 25, 50, 75 can be provided by other computing devices, such as user computing devices, communicating with the system 100 over an interface. The interface can be a web application, a standalone desktop application, API or RPC calls, and so on.

Input data 25, 50, 75 can include data components of different modalities. For example, input data 25 can include an image, some form of written text (which itself may be already in a computer-readable format, or provided as an image or video), and some form of structured data, such as a table of columns. As shown in FIG. 1, the system 100 can process input data 25 to generate an output, collectively shown as outputs 99. The outputs 99 can be responsive to one or more tasks the system is configured to perform, e.g., product retail prediction or modeling, anomaly detection, etc.

As one example, the system 100 can be configured to predict customer review ratings of a product. Input data 25 may include images of products, customer reviews of similar or related products, and chart data showing changes in demand and supply of the product. The system 100 can be pretrained according to a multimodal masking loss and different modality-specific masking losses, to learn to generate a joint representation of the input data 25 across all modalities. Further the system 100 can be fine-tuned on labeled training examples to learn to perform a desired machine learning task, such as product rating prediction. The system 100, once fine-tuned, can then perform the task, provided as one or more outputs of outputs 99.

Input data 50 is similar to input data 25 but is entirely missing data corresponding to one or more modalities. For example, the input data 50 may be entirely missing image data, but still include some form of unstructured data, e.g., as text, as well as structured data, e.g., as tabular data or time-series data. In the above example of predicting product demand, input data 50 can correspond to product data that includes other customer product reviews and chart data but does not include images of the product. Despite missing an entire modality's worth of data, the system 100 is able to generate outputs 99 that are similar to the outputs generated from input data 25, when all modalities were present.

Input data 75 is similar to input data but is partially missing data across multiple modalities. For example, imaging data may be partially unusable, e.g., due to low resolution or missing video frames; text data may be incomplete; and tabular/time-series data may be missing columns or data points, respectively. In the above example of predicting product demand, input data 75 can correspond to product data that may have incomplete imaging data, unfinished or partially missing customer product reviews, and/or incomplete chart data, for example data was not recorded consistently over an observation time period. Despite partially missing data of each type of represented modality, the system 100 is able to generate outputs 99 that are similar to the outputs generated from the input 25, when all modalities were present.

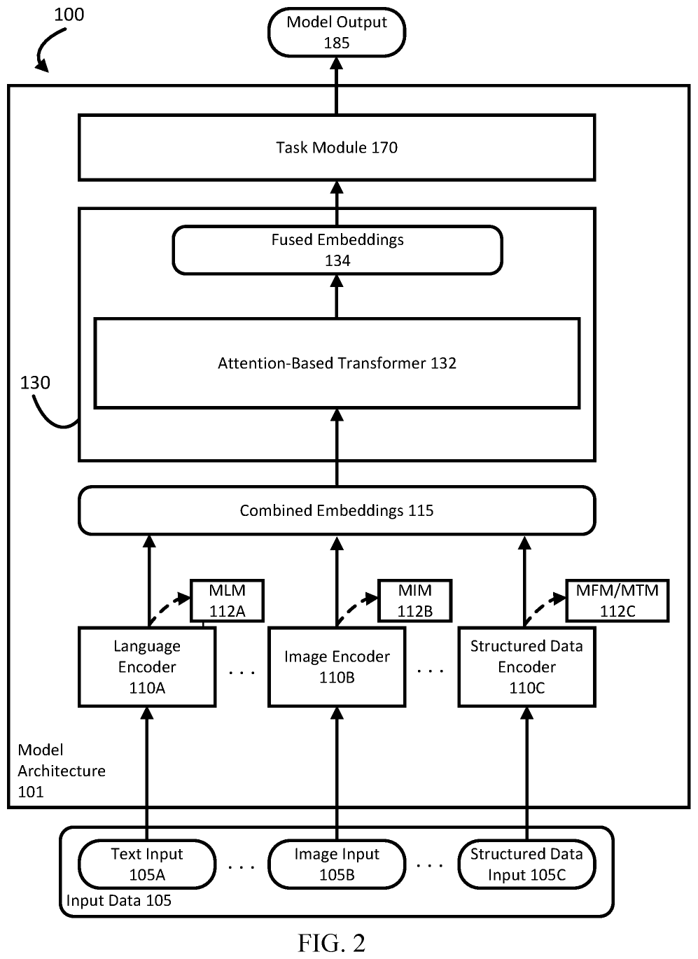

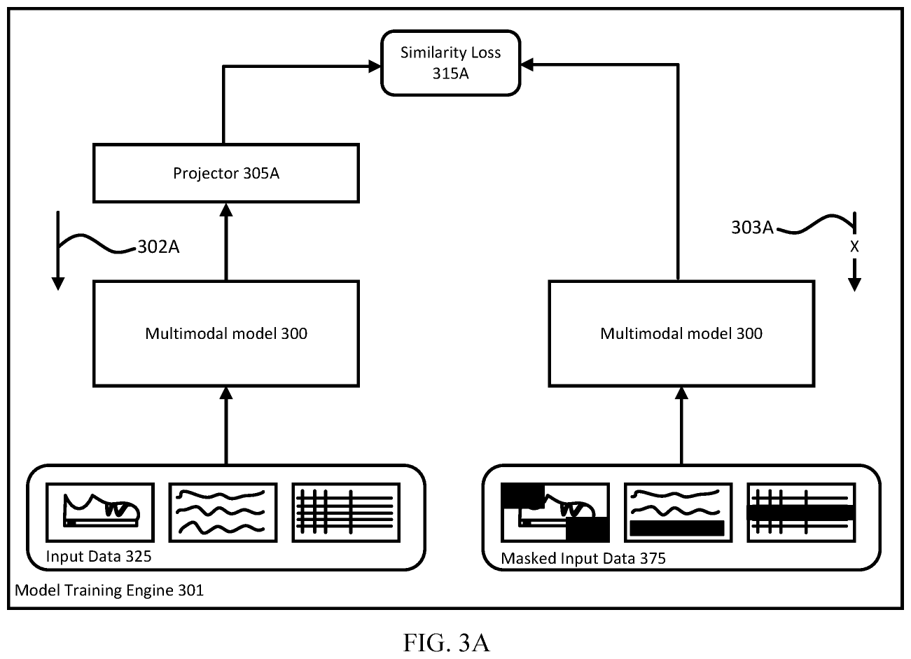

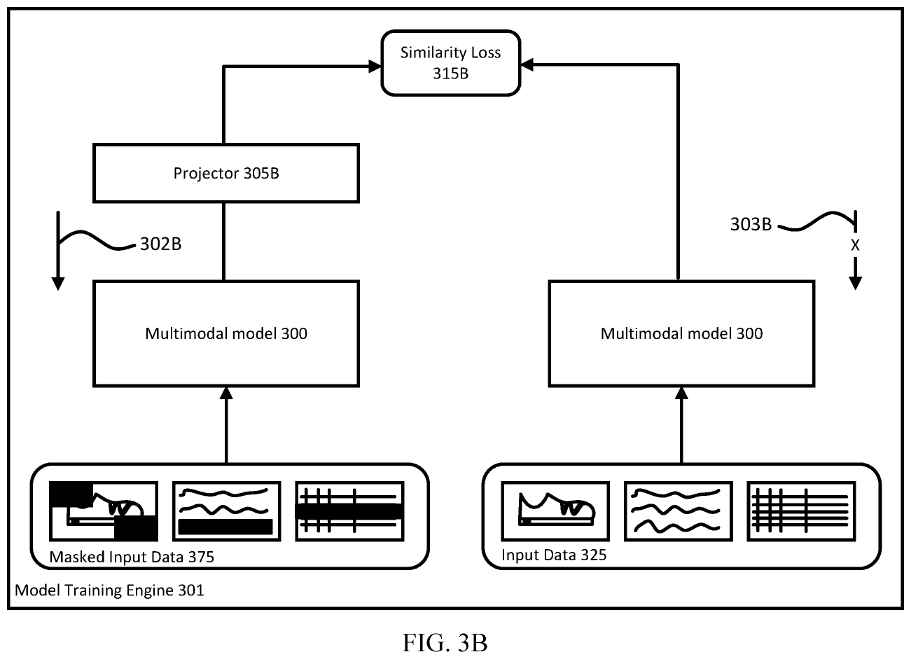

FIG. 2 is a block diagram of an example machine learning model architecture 101 that can be implemented by the multimodal processing system 100, according to aspects of the disclosure. The architecture 101 targets multimodal learning with unstructured data, e.g., vision and language, and structured data, tabular data and time series data. The architecture 101 can be applied to a model. A model training engine, e.g., model training engine 301 of FIG. 3A-3B, can train a model built in accordance with the architecture 101.

In general, input data 105 can contain a combination of data components that is of either structured or unstructured data, as well as of multiple different modalities. Input data 105 is shown with text input 105A, image input 105B, and structured data input 105C, although input data 105 could also include audio input, video input, etc. Structured data input 105C can be further divided between different modalities, for example with tabular data input and time-series data input (not shown).

The system 100 receives the input data 105 and processes data of different modalities according to different modality encoders. Example modality-specific encoders for the system 100 include language encoder 110A, image encoder 110B, and structured data encoder 110C, although other encoders can also be implemented by the model to support encoding data of other modalities. The structured data encoder 110C can be further sub-divided or configured to encode different modalities of structured data separately, for example when the structured data input 105C includes tabular data versus time series data.

The modality-specific encoders 110A-110C can be implemented using attention-based architectures, for example each including attention heads, which themselves can include one or more attention layers and one or more multi-layer perceptrons or other non-linear operations between each attention layer.

The encoders and other components of the multimodal processing system 100 can include a number of predetermined or learnable hyperparameters. Hyperparameters can correspond to characteristics of an architecture for a multimodal model implemented by the system 100, and/or characteristics of pretraining and fine-tuning the model. Example hyperparameters for the multimodal model architecture 101 are provided below.

Embeddings are generated for non-masked input, e.g., input including data for multiple modalities, and for masked input, e.g., input in which data of certain modalities are masked from the model during processing. Embeddings are an example form of encoded representation for the input data 105, which can represent the input data 105 as a vector of numerical values. The system 100 updates these embeddings during processing to generate output in accordance with a fine-tuned machine learning task.

Language encoder 110A can be a text encoder that transforms input text into a list of hidden state vectors, representing intermediate encoded representations. Each hidden state vector can correspond to an input word. Text input to the encoder 110A can be tokenized prior to being processed by the encoder 110A or tokenized by the encoder 110A itself. The encoder 110A can also generate a hidden state vector for an extra text classification token [CLS_T] for representing the input sequence of text. Tokens can be words, sub-words, characters, or any other level of granularity for breaking up text into discrete units. The encoder 110A can receive input within its context window, the size of which can vary from example-to-example. For example, the context window can be based on specifics of the architecture of the encoder 110A, and/or the hardware processing capability and memory of the system 100 executing a model in accordance with the model architecture 101.

The image encoder 110B can be configured to receive patches of input images, e.g., as patches of sixteen for each image. A patch can refer to a sub-image, e.g., a portion of pixels that make up an input image. The pixels may or may not be contiguous in position. The image encoder 110B can also receive or generate positional embeddings encoding the position of each patch relative to an input image. The image encoder 110B generates a list of hidden state vectors as intermediate encoded representations, where each vector corresponds to an image patch or an additional image classification token [CLS_I] for representing the entire image.

Structured data encoder 110C can include one or more sub-encoders (not shown), configured for generating encoded representations of tabular feature data or time-series data, respectively. For example, as a tabular data encoder, the structured data encoder 110C can generate embeddings or other types of encoded representations of time-invariant features, such as numerical or categorical features appearing as columns of a table.

A tabular encoder can be implemented as an encoder-decoder, which encodes tabular data in consecutive multi-steps. Each step can include performing three different processes. First, features can be passed into a back normalization layer, followed by a feature transformer. The feature transformer can implement four gated linear unit (GLU) decision blocks. The encoder can further include a split block configured to divide the processed information to be consumed by an attentive transformer, which performs the sparse feature selection mechanism by learning a mask over different features. The output for the encoder 110C also includes a list of hidden state vectors, generated at the end of each step. Although described in three processes, in various examples the tabular encoder can implement any transformer-based architecture for generated encoded representations of input tabular data.

A time-series encoder can be implemented in accordance with a transformer architecture to encode a multivariate time-series of a fixed length and predetermined number of variables. The output to the time-series encoder includes a list of hidden state vectors as intermediate encoded representations. The encoder can extract temporal information, for example as fully-learnable positional encodings or by some fixed process, e.g., as sinusoidal encodings.

The system 100 combines output from the encoders 110A-110C to form combined embeddings 115. The system generates modality-specific embeddings for the encoders 110A-110C by projecting the lists of hidden states of each encoder to match a target dimension for the multimodal fusion module 130. The modality-specific embeddings are an example of encoded representations of data input to the encoders 110A-110C. The projection can be a linear transformation (not shown in FIG. 2) or one or more other transformations for causing the hidden state lists of each encoder to align in dimensionality, before being combined. In general, the combined embeddings 115 represent or encode at least some data from or based on the modality-specific embeddings generated by the encoders 110A-110C. As one example of combining the output embeddings, the system 100 can concatenate each modality-specific embedding to form the combined embeddings 115.

Multimodal fusion module 130 receives the combined embeddings 115. The module 130 includes an attention-based transformer 132 that can include one or more cross-attention layers. The cross-attention layers are trained to attend to the modality-specific embeddings and generate fused embeddings 134. For example, the attention-based transformer 132 can include six layers, each layer including twelve attention heads. Example hyperparameters and associated values are provided below. The transformer 132 can include other types of layers, including layers for implementing a feed-forward network, layers for performing self-attention on a received input, and layers for adding the normalizing results from previous layers, including feed-forward layers.

Task module 170 can be additional layers of the architecture 101 trained or fine-tuned for performing a particular machine learning task. As described with reference to FIGS. 3A-3B, the system 100 can be trained in a pretraining phase and a fine-tuning phase. In the pretraining phase, the modality-specific encoders 110A-110C and the multimodal fusion module 130 are trained to generate similar embeddings for inputs with and without data of different modalities masked or missing. In the fine-tuning phase, weights learned from the pretraining phase are used to initialize the encoders 110A-110C, 130, and the system 100 is trained end-to-end, from input 105 to model output 185 from the task module 170.

As described herein, the task module 170 can be fine-tuned to perform a variety of downstream tasks after the embeddings are generated, such as classification tasks, regression tasks, or retrieval tasks. Depending on the type of task the system 100 is trained to perform, the task module 170 includes corresponding model architectures and is fine-tuned with corresponding objective functions for fine-tuning the system 100 to perform the selected type of task.

### Example Pretraining and Fine-Tuning

FIG. 3A is a block diagram of a first portion of an example pipeline implemented by a model training engine 301 for computing a masking multimodal loss for training a multimodal model 300, according to aspects of the disclosure. Rather than training the model to reconstruct a missing modality from input data, the model is trained to maximize similarities between masked and un-masked data representations. For example, input data can include multiple modality-specific inputs, for example as shown in FIG. 2 and input data 105, with text input 105A, image input 105B, and structured data input 105C. Input data can take the form X=(I, L, T), where I, L, and T represent image, language, and time series/tabular modality-specific inputs, respectively.

The system 100 can include a model training engine 301 configured to perform the operations described herein with reference to generating training data and training the system 100. The model training engine 301 can perform pretraining to initialize weights of the system 100, followed by a fine-tuning phase to train the system 100 to perform a desired machine learning task.

The training engine 301 generates training data by creating masked views of the input data X, represented as \hat{X}=(Î, \hat{L}, \hat{T}). To generate a masked view, the training engine 301 can randomly remove some data from each modality-specific input. For example, to generate a masked view of image data, the training engine 301 randomly removes patches of the images. To generate a masked view of language data in the form of text, the training engine 301 can randomly replace some words or sub-words with a predetermined token, e.g., a [MASK] token in place of the replaced word or sub-word. For tabular data, the training engine 301 can mask some or all parts of columns in the input tables. In time series data, the training engine 301 can remove timestamps across different time events represented in the data.

The random selection of portions of modality-specific input to mask can be implemented according to any random or pseudorandom process. For example, the training engine 301 can sample from a random distribution to determine, for each unit of data, e.g., sub-word, image patch, column, timestamp, etc., whether to mask the unit. In some examples, the training engine 301 performs multiple passes over the modality-specific input to mask data until a predetermined minimum, maximum, and/or target proportion of the data is masked. An example target proportion of data masked is 15%, but the proportion can vary from example-to-example.

The model training engine 301 performs separate forward passes of the input data 325 and the masked input data 375 through multimodal model 300. The model 300 can be built as described with reference to FIG. 1 and system 100. In the pretraining phase, the task module for the model 300 is either bypassed or not present at all. The output of the model 300 in the pretraining phase is the output of the model's multimodal fusion module, e.g., an output embedding of the input data.

Both inputs are processed through modality-specifier encoders and the multimodal fusion module, for example as described with reference to FIG. 2, the input data 105, the input encoders 110A-110C, and the fusion module 130. The model 300 can be represented by f, and the output of processing the input data 325 (X) and masked input 375 (\hat{X}) through the model 300 can be represented as z₁=f(X) and z₂=f(\hat{X}), respectively. The model training engine 301 projects the output 21 using a projector 305 (p), to project the model output to a final embedding. The final embedding can be represented as e₁=p(z₁).

When the output z₁ is projected, the dimensionality of the resulting projected embedding e₁ matches the dimensionality of output z₂. Similarly, when the output z₂ is projected the dimensionality of a resulting projected embedding e₂ matches the dimensionality of output z₁. The projector 305 can be configured to project input according to a predetermined dimensionality, e.g., based on the dimensionality of the non-projected output from the model 300. The projector 305 can include one or more parameters that can be updated during pretraining or be implemented as one or more operations for projecting input to a target output dimensionality.

The training engine 301 computes similarity loss 315A between the final embedding projected by the projector 305 for the input data 325 and the output embedding of the model 300 for the masked input data 375. The similarity loss 315A rewards maximizing the similarity between the two embeddings e₁ and z₂ during training,

One example of a function for computing the similarity loss 315A is computing the negative cosine similarity between projected embeddings (e₁) of the input data 325 and the output embeddings (z₂) of the masked input data 375. An example formulation of the similarity loss 315A calculation is:

$$D ( {e}_{1} , {z}_{2} ) = - \frac{{e}_{1}}{{‖ {e}_{1} ‖}_{2}} \cdot \frac{{z}_{2}}{{‖ {z}_{2} ‖}_{2}}$$

where ∥⋅∥₂ is the l₂-norm. The similarity loss 315A is part of a total masking multimodal loss used by the training engine 301 to train the model 300.

FIG. 3B is a block diagram of a second portion of an example pipeline implemented by the model training engine 301 for computing a multimodal masking loss for training a multimodal model 300, according to aspects of the disclosure. Instead of using projector 305 to project the output embeddings z₁ generated by processing the input data 325 through the model 300, the training computes projected embeddings e₂ using projector 305 receiving output embeddings (z₂) output by the model 300 in processing the masked input data 375. An example formulation of the similarity loss 315B calculation is:

$$D ( {e}_{2} , {z}_{1} ) = - \frac{{e}_{2}}{{‖ {e}_{2} ‖}_{2}} \cdot \frac{{z}_{1}}{{‖ {z}_{1} ‖}_{2}}$$

The total masking multimodal loss rewards learning cross-modal relations, represented by reducing the loss when the cosine similarity between the embeddings of a masked input and a non-masked input is maximized. An example formulation of the total masking multimodal loss is:

$${L}_{S i m M M M} = D ( {e}_{1} , {z}_{2} ) + D ( {e}_{2} , {z}_{1} )$$

where e₂ is a projected embedding generated by the training engine as described presently with reference to FIG. 3B. Although described as being projected by the same projector 305, in it is understood that in various examples, the projected embeddings e₁ and e₂ may be generated using linear or non-linear transformations of separate projectors.

During the backward pass, the weight updates applied on the model 300 stemming from the similarity losses 315A, 315B vary, indicated by gradient indicators 302A, 303A, 302B, and 303B. A ‘stop-gradient’ can be applied to avoid or mitigate degenerate solutions. In FIG. 3A, gradients from z₂ are stopped in the first term D (e₁, z₂) for weights of the model 300, while gradients from e₂ are stopped in the second term D (e₂, z₁). In FIG. 3B, the output from the masked input data 375 is encoded and projected as projected embedding e₂. During the backward pass, gradients from z₁ are stopped in the second term D (e₂, z₁), while the gradients from e₁ are stopped in the first term D (e₁, z₂). To stop a gradient, the engine 301 can treat the corresponding variable as a constant (e.g., to invoke a gradient of zero).

Referring back to FIG. 2, additional modality-specific losses 112A-112C can be computed by the training engine 301 for each modality-specific encoder 110A-110C. In FIG. 2, loss MLM 112A (LMLM) is a loss computed for language encoder 110A, loss MIM 112B (LMIM) is a loss computed for image encoder 110B, and loss MFM/MTM 112C (L_{MFM}, L_{MTM}) corresponds to losses computed for structured data encoder 110C. For the structured data encoder 110C, the specific loss calculation performed depends on whether the encoder 110C is configured for tabular feature encoding (corresponding to loss MFM (L_{MFM})) or time-series data encoding (corresponding to loss MTM (L_{MTM})).

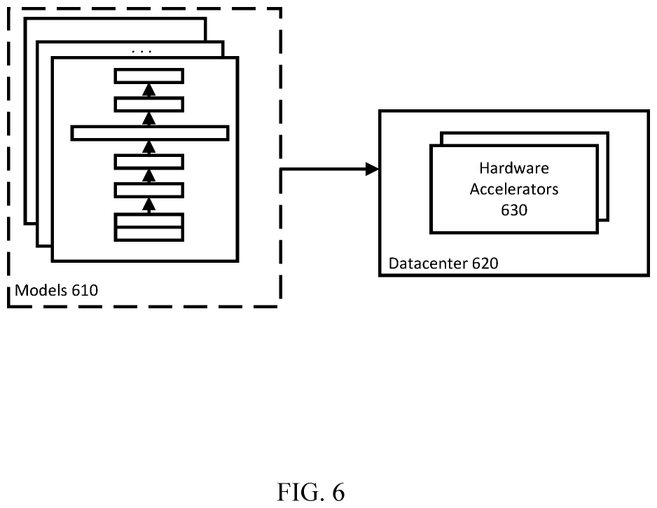

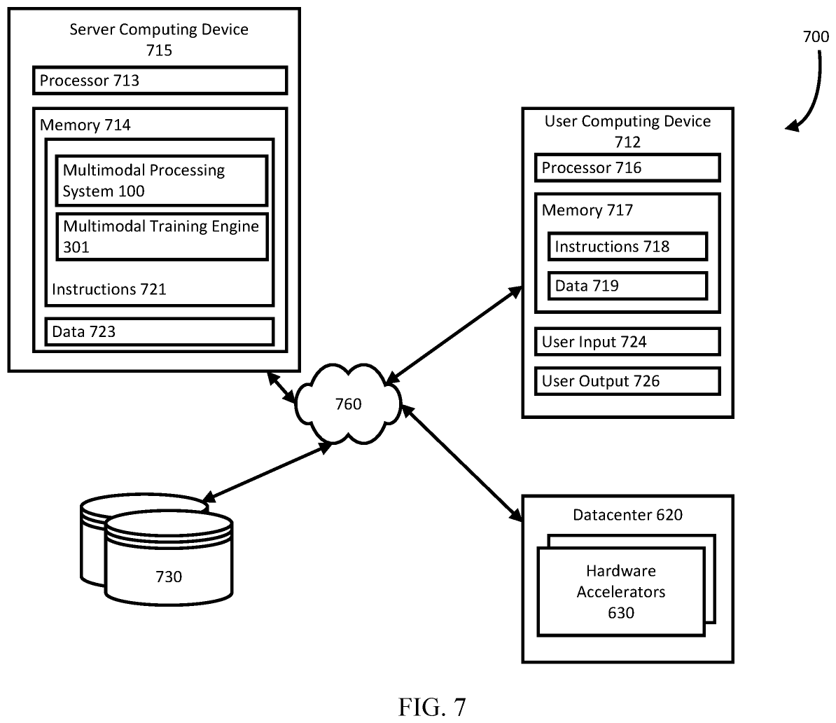

Classifier heads or other modules described for computing the modality-specific losses 112A-112C are not shown in FIG. 2 but may be used when pretraining the system 100. Outside of pretraining, these modules may be removed or bypassed when computing the modality-specific losses 112A-112C are not required. Each individual module for computing the loss may be trained, for example as described with reference to FIGS. 6 and 7. In some examples, pretrained modules on top of the modality-specific encoders 110A-110C are used during the pretraining phase of the system 100.

Masked signal modeling can be used as a general self-supervised learning strategy for all the modality-specific encoders of the system 100. Non-parallel data can be used for the modality-specific encoders, as masked inputs are fed to the encoders and a form of reconstruction or prediction task is used for training. The specific task can vary depending on the corresponding modality-specific encoder, and the module trained to perform the task, e.g., a classification head, a feed-forward network, is not shown in FIG. 2. The modality-specific losses shown and described here with reference to masking losses for language, image, tabular, and time-series modalities, are examples and not meant to be exhaustive. In some examples, other types of losses are computed and used for pretraining the system 100, such as losses for audio, video, or losses for other types of structured data.

L_{MLM}: Model training engine 301 can compute the masked language modeling loss MLM 112A using a decoder with a classifier head on top of the language encoder 110A. The classifier head can be trained to predict masked tokens out of an entire vocabulary, given un-masked tokens as input.

L_{MIM}: Model training engine 301 can compute the masked image modeling loss MIM 112B using a decoder trained to reconstruct raw pixels of masked image patches, given the rest of the image. The decoder can include a linear layer on top of the latent feature representation of the image encoder 110B and can be trained according to techniques described herein with reference to FIGS. 6 and 7, with an l₁ loss.

L_{MFM}: Model training engine 301 can compute the masked feature modeling loss MFM 112C using a decoder on top of the structured data encoder 110C configured for encoding tabular feature data. The decoder can apply one or more feature transformers on embeddings generated by the structured data encoder 110C, and further process decoded output through one or more fully-connected layers. This module is trained to reconstruct missing tabular features given the un-masked columns of the input. The outputs from the decoder are average to obtain the reconstructed features.

L_{MTM}: The model training engine 301 trains the structured data encoder 110C with a self-supervised masking modeling objective, with the task of regressing to masked values from input time-series data. For example, a binary noise mask is applied by the training engine 301 to each received data point, where on average 15% of each column of data (each corresponding to a single variable) is set to zero. Other average percentages may be used, in different examples. A geometric distribution can be applied in zeroing out different columns of data, to avoid the model from trivially predicting missing values, for example by replacing missing values with the immediately preceding or succeeding values, or their averaged value. An additional module including a linear layer can be placed on top of the time-series embeddings of the structured data encoder 110C, which is trained to output a vector of equal size as the input. The model training engine 301 can compute the loss as a mean squared error loss for the masked values. This approach is in contrast with other denoising approaches in autoencoders, in which the entire input is injected with Gaussian noise and is reconstructed as a whole.

The full objective function used by the training engine 301 combines all of the modality-specific masking losses and the multimodal masking loss. An example formulation of the full objective function is:

$${L}_{Total} = {λ}_{1} {L}_{MLM} + {λ}_{2} {L}_{MIM} + {λ}_{3} {L}_{MFM} + {λ}_{4} {L}_{MTM} + {λ}_{5} {L}_{SimMMM}$$

where λ₁, λ₂, λ₃, λ₄, λ₅ are hyperparameters that determine the effect of each loss component during pretraining. Each of the hyperparameters can take on a range of different values, e.g., from 0 to 1.

After pretraining, the pretrained weights can be used to initialize both modality-specific encoders and the multimodal encoder of the multimodal system 100. Task module 170 can be added for training the system 100 to perform a particular task, e.g., classification, regression, retrieval, etc. The architecture of the module 170 can vary from example-to-example. In some examples, the task module 170 includes a multilayer perceptron or a feedforward network with trainable weights and which outputs a result or classification in accordance with the task for which the model is being trained 100. The system 100 can be trained end-to-end with the task module 170, or some or all of the weights in the system 100 outside of the weights in the task module 170 may be frozen or made static during training. Example use cases and training methods are provided herein with reference to FIGS. 6 and 7.

### Example Methods

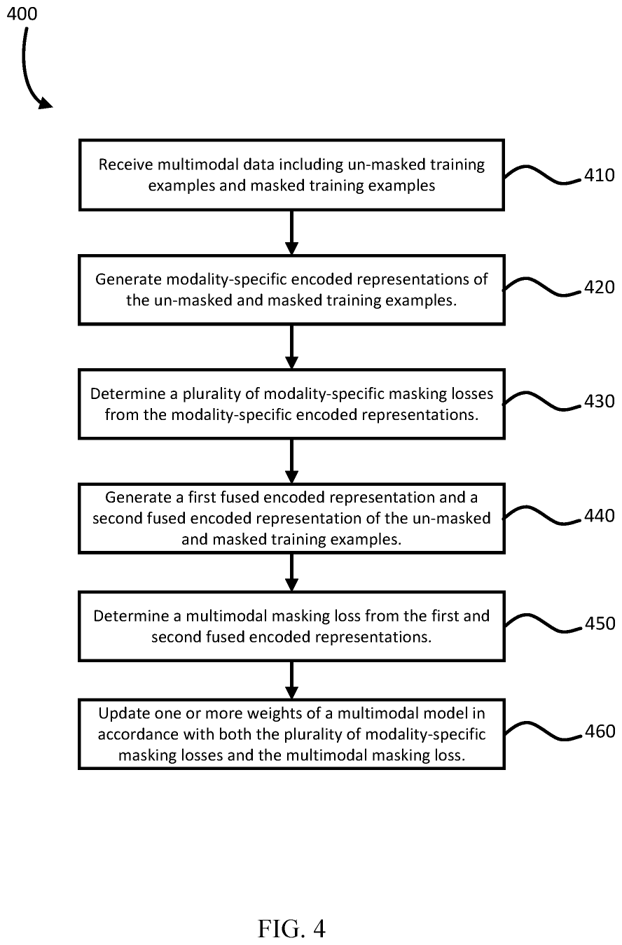

FIG. 4 depicts a flow diagram of an example process 400 for pretraining a multimodal model, according to aspects of the disclosure. The example process can be performed on a system of one or more processors in one or more locations, such as the server computing device implementing the multimodal training engine 301, as shown and described with reference to FIG. 7. The following operations do not have to be performed in the precise order described below. Rather, various operations can be handled in a different order or simultaneously, and operations may be added or omitted. The system as shown and described with reference to FIGS. 1-2 can perform the process 400, for example through the model training engine 301. In some examples, the model training engine 301 is implemented on one or more devices separate from devices implementing the system 100.

The system receives multimodal data including un-masked training examples and masked training examples, according to block 410. The training examples include structured data, and at least one other modality of unstructured data, e.g., text data, image data, video, audio data, etc. The structured data in the training examples can include one or more of tabular feature data or time-series data, although in general the structured data can include any type of format following a predetermined format or structure.

The masked training examples are at least partially masked versions of the un-masked training examples. A partially masked training example can include missing portions of some or all of the modalities of data present in the training example, entirely missing modalities altogether, or a combination of some combination of the two. As shown and described with reference to FIG. 1, input data 25, 50, and 75 are examples of data that can be either un-masked (e.g., input data 25) or masked (e.g., input data 50, 75). As part of receiving the multimodal data, the system can be configured to randomly mask un-masked training examples, for example according to a target proportion, e.g., 15%.

The system generates modality-specific encoded representations of the un-masked and masked training examples, according to block 420. Examples of modality-specific encoded representations include embeddings and/or hidden state vectors generated by modality-specific encoders of the multimodal model, e.g., modality-specific encoders 110A-110C as shown and described with reference to FIG. 2. The system can generate a structured data encoded representation using a structured data encoder, which can be further sub-divided into an encoder for time-series data and/or an encoder for tabular feature data.

The system determines a plurality of modality-specific masking losses from the modality-specific encoded representations, according to block 430. As shown and described with reference to FIG. 2, modality-specific masking losses can be the masking losses 112A-112C. Various techniques can be used to generate these masking losses, consistent with the modality of the data processed by modality-specific encoders of the multimodal model. The modality-specific masking losses measure a similarity between encoded representations generated using masked training examples, and their corresponding un-masked training example counterparts.

The system generates a first and a second fused encoded representation of the un-masked and the masked training examples, according to block 440. The fused embeddings generated by the fusion module 130 as shown and described in FIG. 2 are examples of fused encoded representations. The system can generate the first and the second fused encoded representations by processing the modality-specific encoded representations through an attention-based transformer. The fusion module 130 can at least partially implementing the attention-based transformer.

The system determines a multimodal masking loss from the first and the second fused encoded representations, according to block 450. The multimodal masking loss measures the similarity between the first and the second fused encoded representation. For example, the multimodal masking loss can be computed as the sum of (1) a negative cosine similarity between a projection of the first fused encoded representation and the second fused representation, and (2) a negative cosine similarity between a projection of the second fused representation and the first fused encoded representation.

The system updates one or more weights of a multimodal model in accordance with both the plurality of modality-specific masking losses and the multimodal masking loss, according to block 460. The system can compute a total loss as a function of the modality-specific masking losses and the multimodal masking losses, weighted according to respective hyperparameter values.

After the multimodal model is pretrained, the system can fine-tune or further train the model to perform a machine learning task. The model can be trained according to a variety of different learning techniques. Learning techniques for fine-tuning or further training the multimodal models can include supervised learning, unsupervised learning, self-supervised learning, semi-supervised learning, and reinforcement learning techniques. For example, training data can include multiple training examples that can be received as input by a model. The training examples can be labeled with a desired output for the model when processing the labeled training examples. The label and the model output can be evaluated through a loss function to determine an error, which can be calculated during a forward pass and backpropagated through the model with gradient descent during a backward pass, to update weights for the model. For example, a supervised learning technique can be applied to calculate an error between outputs, with a ground-truth label of a training example processed by the model.

In fine-tuning the multimodal model, any of a variety of loss or error functions appropriate for the type of the task the model is being trained for can be utilized, such as cross-entropy loss for classification tasks, or mean square error for regression tasks. The gradient of the error with respect to the different weights of the candidate model on candidate hardware can be calculated, for example using a backpropagation algorithm with gradient descent, and the weights for the model can be updated.

The model or policy can be pretrained, trained, or fine-tuned over one or more iterations until stopping criteria are met, such as a number of iterations for training, a maximum period of time, a convergence of estimated rewards or value between actions, or when a minimum value or accuracy threshold is met. A multimodal model can be a composite of multiple models or components of a processing or training pipeline. In some examples, the models or components are trained separate, while in other examples, the models or components are trained end-to-end.

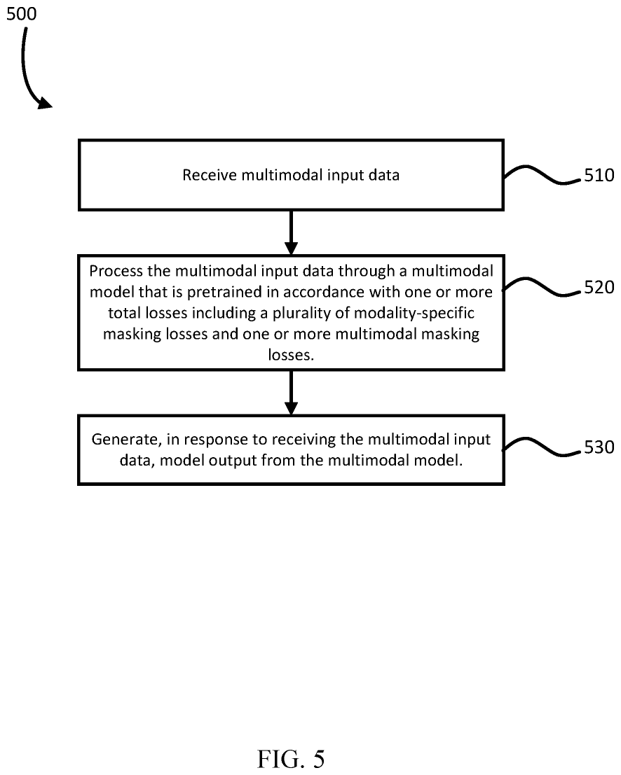

FIG. 5 is a flow diagram of an example process 500 of processing input through a multimodal model pretrained according to aspects of the disclosure. A system including one or more processors, such as the multimodal processing system 100 of FIG. 1, can perform the process 500. The following operations do not have to be performed in the precise order described below. Rather, various operations can be handled in a different order or simultaneously, and operations may be added or omitted.

The system receives multimodal input data, according to block 510. Multimodal data can include combinations of structured and unstructured data, with some or all information for one or more modalities missing from the input data.

The system processes the multimodal input data through a multimodal model that is pretrained with one or more total losses including a plurality of modality-specific masking losses and one or more multimodal masking losses, according to block 520. The pretraining can be performed over one or more pretraining iterations, which may correspond to respective training epochs. At each iteration, the system pretraining the model computes one or more total losses based on computed modality-specific and multimodal masking losses, for example as described herein with reference to the model training engine 301 of FIGS. 3A-3B and the process 400 of FIG. 4.

In some examples, the system processing the multimodal model can be the same system that pretrained or fine-tuned the model. In various examples, different systems of devices in one or more locations can separately pretrain, fine-tune, and process input through the multimodal model, consistent with aspects of the disclosure.

The system generates, in response to receiving the multimodal input data, model output from the multimodal model, according to block 530. The model output can be generated after the model is fine-tuned to generate the output in accordance with a machine learning task.

Implementations of the present technology can each include, but are not limited to, the following. The features may be alone or in combination with one or more other features described herein. In some examples, the following features are included in combination:
(1) A method of pretraining a multimodal model, the method including: receiving, by one or more processors, multimodal training data including un-masked training examples and masked training examples; and performing, by the one or more processors, one or more pretraining iterations including: generating modality-specific encoded representations of the un-masked training examples and masked training examples, determining a plurality of modality-specific masking losses measuring the similarity between the modality-specific encoded representations of the un-masked training examples and the masked training examples. generating a first fused encoded representation of the un-masked training example encoded representations and a second fused encoded representation of the masked training example encoded representations, determining a multimodal masking loss measuring the similarity between the first fused encoded representation and the second fused encoded representation, and updating, by the one or more processors, one or more weights of the multimodal model in accordance with both the plurality of modality-specific masking losses and the multimodal masking loss.
(2) The method of (1), wherein the masked training examples include data that is least partially masked or removed from the un-masked training examples.
(3) The method of either (1) or (2), wherein the multimodal training data includes data of a plurality of modalities, including structured data and at least one of text data, image data, video data, or audio data.
(4) The method of (3), wherein the structured data includes tabular feature data, time-series data, or both the tabular feature data and the time-series data.
(5) The method of (4), wherein generating the modality-specific encoded representations includes generating, by the one or more processors, a structured data encoded representation using a structured data encoder of the multimodal model.
(6) The method of any one of (3) through (5), further including: receiving, by the one or more processors, labeled training data including labeled training examples corresponding to a machine learning task; and performing, by the one or more processors, one or more fine-tuning iterations of: processing the labeled training data through the multimodal model, determining a task-specific loss measuring performance of the multimodal model in performing the machine learning task, and updating weights of the multimodal model in accordance with the task-specific loss.
(7) The method of (6), further including: after performing the one or more pretraining iterations and the one or more fine-tuning iterations, processing, by the one or more processors, instances of multimodal data input through the multimodal model to generate output in accordance with the machine learning task, wherein: one or more instances include data of each modality of the plurality of modalities present in the multimodal training data, and each instance other than the one or more instances includes different respective combinations of at least partially missing data of at least one modality of the plurality of modalities present in the multimodal training data.
(8) The method of any one of (1) through (7), wherein generating the first fused encoded representation and the second fused encoded representation includes processing, by the one or more processors, the modality-specific encoded representations through a plurality of cross-attention layers of an attention-based transformer.
(9) The method of any one of (1) through (7), wherein the multimodal masking loss includes: a negative cosine similarity between a projection of the first fused encoded representation and the second fused representation, and a negative cosine similarity between a projection of the second fused representation and the first fused encoded representation.
(10) The method of (9), wherein updating the one or more weights includes calculating a total loss as the sum of the plurality of modality-specific masking losses and the multimodal masking loss, each of the masking losses weighted by a respective hyperparameter value; and updating the one or more weights of the multimodal model using backpropagation with gradient descent and the total loss.
(11) A system including one or more processors and memory, the system configured to perform, by the one or more processors, operations of the method of any one of (1) through (10).
(12) One or more non-transitory computer-readable storage media storing instructions that are operable, when executed by one or more processors, to cause the one or more processors to perform operations as in any one of claims (1)-(10).

### Example Model Architectures, Training, and Computing Environments

FIG. 6 is a block diagram illustrating one or more models 610, such as for deployment in a datacenter 620 housing one or more hardware accelerators 630 on which the deployed models will execute for multimodal input processing. The hardware accelerators 630 can be any type of processor, such as a central processing unit (CPU), graphics processing unit (GPU), field-programmable gate array (FPGA), or an application-specific integrated circuit (ASIC), such as a tensor processing unit (TPU).

An architecture of a model can refer to characteristics defining the model, such as characteristics of layers for the model, how the layers process input, or how the layers interact with one another. As an example, the architecture of a model can include self-attention or cross-attention layers, implemented as part of an attention-based transformer. The transformer can have a number of different heads attending to different parts of the input received by the model or trained to perform other operations.

As another example, the model can include neural network or other types of non-linear models. For instance, a model can include a number of feed-forward layers, normalization layers, encoding layers, decoding layers, all representing different types or learnable or predetermined operations that is performed by processors implementing a machine learning model. The architecture of the model can also define types of operations performed within each layer. Other example architectures can include generative models, such as language models, foundation models, and/or graphical models. One or more model architectures can be generated that can output results associated with multimodal model processing.

FIG. 7 is a block diagram of an example computing environment 700 for implementing the multimodal processing system 100 and the multimodal training engine 301. The system 100 and the multimodal training engine 301 can be implemented on one or more devices having one or more processors in one or more locations, such as in server computing device 715. User computing device 712 and the server computing device 715 can be communicatively coupled to one or more storage devices 730 over a network 760. The storage device(s) 730 can be a combination of volatile and non-volatile memory and can be at the same or different physical locations than the computing devices 712, 715. For example, the storage device(s) 730 can include any type of non-transitory computer readable medium capable of storing information, such as a hard-drive, solid state drive, tape drive, optical storage, memory card, ROM, RAM, DVD, CD-ROM, write-capable, and read-only memories.

Aspects of the disclosure can be implemented in a computing system that includes a back-end component, e.g., as a data server, a middleware component, e.g., an application server, or a front-end component, e.g., user computing device 712 having a user interface, a web browser, or an app, or any combination thereof. The components of the system can be interconnected by any form or medium of digital data communication, such as a communication network. Examples of communication networks include a local area network (LAN) and a wide area network (WAN), e.g., the Internet. The datacenter 620 can also be in communication with the user computing device 712 and the server computing device 715.

The computing system can include clients, e.g., user computing device 712 and servers, e.g., server computing device 715. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

The server computing device 715 can include one or more processors 713 and memory 714. The memory 714 can store information accessible by the processor(s) 713, including instructions 721 that can be executed by the processor(s) 713. The memory 714 can also include data 723 that can be retrieved, manipulated, or stored by the processor(s) 713. The memory 714 can be a type of non-transitory computer readable medium capable of storing information accessible by the processor(s) 713, such as volatile and non-volatile memory. The processor(s) 713 can include one or more central processing units (CPUs), graphic processing units (GPUs), field-programmable gate arrays (FPGAs), and/or application-specific integrated circuits (ASICs), such as tensor processing units (TPUs).

The instructions 721 can include one or more instructions that when executed by the processor(s) 713, causes the one or more processors to perform actions defined by the instructions. The instructions 721 can be stored in object code format for direct processing by the processor(s) 713, or in other formats including interpretable scripts or collections of independent source code modules that are interpreted on demand or compiled in advance. The instructions 721 can include instructions for implementing the system 100 and the model training engine 301 consistent with aspects of this disclosure. The system 100 and the model training engine 301 can be executed using the processor(s) 713, and/or using other processors remotely located from the server computing device 715.

The data 723 can be retrieved, stored, or modified by the processor(s) 713 in accordance with the instructions 721. The data 723 can be stored in computer registers, in a relational or non-relational database as a table having a plurality of different fields and records, or as JSON, YAML, proto, or XML documents. The data 723 can also be formatted in a computer-readable format such as, but not limited to, binary values, ASCII, or Unicode. Moreover, the data 723 can include information sufficient to identify relevant information, such as numbers, descriptive text, proprietary codes, pointers, references to data stored in other memories, including other network locations, or information that is used by a function to calculate relevant data.

The user computing device 712 can also be configured similar to the server computing device 715, with one or more processors 716, memory 717, instructions 718, and data 719. For example, the user computing device 712 can be a mobile device, a laptop, a desktop computer, a game console, etc. The user computing device 712 can also include a user output 726, and a user input 724. The user input 724 can include any appropriate mechanism or technique for receiving input from a user, including acoustic input; visual input; tactile input, including touch motion or gestures, or kinetic motion or gestures or orientation motion or gestures; auditory input, speech input, etc., Example devices for user input 724 can include a keyboard, mouse or other point device, mechanical actuators, soft actuators, touchscreens, microphones, and sensors.

The server computing device 715 can be configured to transmit data to the user computing device 712, and the user computing device 712 can be configured to display at least a portion of the received data on a display implemented as part of the user output 726. The user output 726 can also be used for displaying an interface between the user computing device 712 and the server computing device 715. The user output 726 can alternatively or additionally include one or more speakers, transducers or other audio outputs, a haptic interface or other tactile feedback that provides non-visual and non-audible information to the platform user of the user computing device 712.

Although FIG. 7 illustrates the processors 713, 716 and the memories 714, 717 as being within the computing devices 715, 712, components described in this specification, including the processors 713, 716 and the memories 714, 717 can include multiple processors and memories that can operate in different physical locations and not within the same computing device. For example, some of the instructions 721, 718 and the data 723, 719 can be stored on a removable SD card and others within a read-only computer chip. Some or all of the instructions and data can be stored in a location physically remote from, yet still accessible by, the processors 713, 716. Similarly, the processors 713, 716 can include a collection of processors that can perform concurrent and/or sequential operation. The computing devices 715, 712 can each include one or more internal clocks providing timing information, which can be used for time measurement for operations and programs run by the computing devices 715, 712.

The server computing device 715 can be configured to receive requests to process data from the user computing device 712. For example, the environment 700 can be part of a computing platform configured to provide a variety of services to users, through various user interfaces and/or APIs exposing the platform services. One or more services can be a machine learning framework or a set of tools for training or executing generative models or other machine learning models according to a specified task and training data.

The devices 712, 715 can be capable of direct and indirect communication over the network 760. The devices 715, 712 can set up listening sockets that may accept an initiating connection for sending and receiving information. The network 760 itself can include various configurations and protocols including the Internet, World Wide Web, intranets, virtual private networks, wide area networks, local networks, and private networks using communication protocols proprietary to one or more companies. The network 760 can support a variety of short-and long-range connections. The short-and long-range connections may be made over different bandwidths, such as 2.402 GHz to 2.480 GHz (commonly associated with the Bluetooth® standard), 2.4 GHz and 5 GHz (commonly associated with the Wi-Fi® communication protocol); or with a variety of communication standards, such as the LTER standard for wireless broadband communication. The network 760, in addition or alternatively, can also support wired connections between the devices 712, 715, including over various types of Ethernet connection.

Although a single server computing device 715, user computing device 712, and datacenter 620 are shown in FIG. 7, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

### Example Encoder and Training Hyperparameters

The modality-specific and multimodal encoders of the model described herein can be implemented according to a variety of different hyperparameters. Example parameters are provided here, but it is understood that each and every hyperparameter can take on different values, and some hyperparameters may be added while others are removed in various different examples. The exact encoders and hyperparameters used can vary depending on the type of task the multimodal model is ultimately trained to perform. For example, an encoder for tabular feature data may be omitted if the input is predetermined to not include tabular data. Similarly, an encoder for time-series data may be omitted if the input data is predetermined to not include time-series data.

Example hyperparameters for the modality-specific language encoder are shown in TABLE A.

TABLE A

| Hyperparameter | Value |
|---|---|
| Number of heads | 12 |
| Number of layers | 12 |
| Hidden size | 768 |
| Intermediate size | 3072 |
| Projection size | 768 |
| Vocab size | 30522 |
| Maximum sequence length | 512 |
| Masking ratio | 0.15 |

Example hyperparameters for the modality-specific image encoder are shown in TABLE B.

TABLE B

| Hyperparameter | Value |
|---|---|
| Number of heads | 12 |
| Number of layers | 12 |
| Hidden size | 768 |
| Intermediate size | 3072 |
| Projection size | 768 |
| Patch size | 16 |
| Image size | 224 |
| Masking ratio | 0.5 |

Example hyperparameters for the modality-specific time-series data encoder are shown in TABLE C.

TABLE C

| Hyperparameter | Value |
|---|---|
| Number of heads | 4 |
| Number of layers | 3 |
| Hidden size | 256 |
| Intermediate size | 3072 |
| Projection size | 768 |
| Positional Encoder | learnable |
| Normalization | LayerNorm |
| Masking ratio | 0.15 |
| Average mask length | 3 |
| Masking sampling strategy | Geometric |
| Time series length | 48 |

In TABLE C, LayerNorm refers to the specific technique applied for normalization in the encoder. Position encoding is learnable instead of predetermined, and a geometric masking sampling strategy is selected to avoid masking some data points that may be trivially reconstructed by taking the value of preceding or succeeding values, or by an average.

Example hyperparameters for the modality-specific time-series data encoder are shown in TABLE D.

TABLE D

| Hyperparameter | Value |
|---|---|
| Number of heads | 4 |
| Number of layers | 3 |
| Hidden size | 1024 |
| Attention size | 64 |
| Masking function | Sparsemax |
| Projection size | 256 |
| Masking ratio | 0.15 |

In TABLE D, sparsemax is a type of masking function that can be used in some examples. Example hyperparameters for the multimodal encoder are shown in TABLE E.

TABLE E

| Hyperparameter | Value |
|---|---|
| Number of heads | 12 |
| Number of layers | 6 |
| Intermediate size | 3072 |
| Projection hidden dimension | 768 |
| Projection size | Sparsemax |

Example hyperparameters for pretraining the multimodal model are shown in TABLE F.

TABLE F

| Hyperparameter | Values |
|---|---|
| Learning rate | 0.0001 |
| Batch size | 64, 128 |
| AdamW weight decay | 0.02 |
| AdamW β₁ | 0.9 |
| AdamW β₂ | 0.999 |
| Learning rate schedule | Cosine |
| | Annealing |
| λ₁ | 1. |
| λ₂ | 1. |
| λ₃ | 0, 0.01 |
| λ₄ | 0, 0.01 |
| λ₅ | 0.5 |

Example hyperparameters for fine-tuning the multimodal model are shown in TABLE E.

TABLE G

| Hyperparameter | Values |
|---|---|
| Learning rate | 0.0001, |
| | 0.00005 |
| Batch size | 32, 128, |
| | 512 |
| AdamW weight decay | 0.02, 0.1 |
| AdamW β₁ | 0.9, 0.1 |
| AdamW β₂ | 0.999 |
| Learning rate schedule | Cosine |
| | Annealing |

In TABLE G, AdamW weight decay, β₁, and β₂ refer to hyperparameters for applying the AdamW adaptive optimizer. In various examples, different optimizers may be applied to improve pretraining or fine-tuning, while in other examples, no optimizers are used at all. Similarly, the learning rate schedule applied during pretraining or fine-tuning may be cosine annealing as shown in TABLE G, while in other examples, other schedules may be used. In yet other examples, no schedule is used at all, and the learning rate is static during fine-tuning and/or pretraining.

### Example Experimental Results

Examples of the described multimodal processing system were evaluated against various test benchmarks. In one example, an example implementation of the system was tested on a dataset of product reviews across a variety of different categories, with the objective of predicting a star rating, e.g., out of 5. Pretraining was performed over approximately 5.6 million training examples, and fine-tuning was processed on far fewer examples, e.g., 512 examples. Training examples included triplets encompassing image, text, and tabular features. Product images include seller or user-provided images, truncated text summaries, and full reviewed limited to 512 characters. Tabular features encompass product ID, reviewer ID, review verification status, year, review ratings count, and timestamp.

Compared to other multimodal processing approaches, improvements were observed of up to 6.6% (AUROC) and 14% (accuracy), when fine-tuned on 0.1% and 0.01% of labeled data, respectively. These improvements were observed even in the presence of missingness ratios of up to 99.8%. Compared to training without masked or missing data, example systems achieved a 6.34% AUROC improvement, indicating that the absence of modalities are used to forge cross-modal relationships, and the example systems are not hindered by their absence.

### Example Use Cases

As described herein, aspects of the disclosure provide for pretraining and fine-tuning a multimodal model. Examples of machine learning tasks performed by the multimodal model after fine-tuning follow.

As an example, the input to the multimodal model can be in the form of images, videos. A multimodal model can be configured to extract, identify, and generate features as part of processing a given input, for example as part of a computer vision task. A multimodal model trained to perform this type of machine learning task can be trained to generate an output classification from a set of different potential classifications. In addition, or alternatively, the multimodal model can be trained to output a score corresponding to an estimated probability that an identified subject in the image or video belongs to a certain class.

As another example, the input to the multimodal model can be data files corresponding to a particular format, e.g., HTML files, word processing documents, or formatted metadata obtained from other types of data, such as metadata for image files. A machine learning task in this context can be to classify, score, or otherwise predict some characteristic about the received input. For example, a multimodal model can be trained to predict the probability received input includes text relating to a particular subject. Also, as part of performing a particular task, the multimodal model can be trained to generate text predictions, for example as part of a tool for auto-completion of text in a document as the document is being composed. A multimodal model can also be trained for predicting a translation of text in an input document to a target language, for example as a message is being composed.

Other types of input documents can be data relating to characteristics of a network of interconnected devices. These input documents can include activity logs, as well as records concerning access privileges for different computing devices to access different sources of potentially sensitive data. A multimodal model can be trained for processing these and other types of documents for predicting on-going and future security breaches to the network. For example, the multimodal model can be trained to predict intrusion into the network by a malicious actor.

As another example, the input to a multimodal model can be audio input, including streamed audio, pre-recorded audio, and audio as part of a video or other source or media. A machine learning task in the audio context can include speech recognition, including isolating speech from other identified sources of audio and/or enhancing characteristics of identified speech to be easier to hear. A multimodal model can be trained to predict an accurate translation of input speech to a target language, for example in real-time as part of a translation tool.

In addition to data input, including the various types of data described herein, a multimodal model can also be trained to process features corresponding to given input. Features are values, e.g., numerical or categorical, which relate to some characteristic of the input. For example, in the context of an image, a feature of the image can relate to the RGB value for each pixel in the image. A machine learning task in the image/video context can be to classify contents of an image or video, for example for the presence of different people, places, or things. Machine learning models can be trained to extract and select relevant features for processing to generate an output for a given input and can also be trained to generate new features based on learned relationships between various characteristics of input data.

Aspects of this disclosure can be implemented in digital electronic circuitry, in tangibly-embodied computer software or firmware, and/or in computer hardware, such as the structure disclosed herein, their structural equivalents, or combinations thereof. Aspects of this disclosure can further be implemented as one or more computer programs, such as one or more engines or modules of computer program instructions encoded on one or more tangible non-transitory computer storage media for execution by, or to control the operation of, one or more data processing apparatus.

A computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, that is generated to encode information for transmission to suitable receiver apparatus for execution by a data processing apparatus. A computer program may, but need not, correspond to a file in a file system. A computer program can be stored in a portion of a file that holds other programs or data, e.g., one or more scripts, in a single file, or in multiple coordinated files, e.g., files that store one or more engines, modules, sub-programs, or portions of code.

The term “configured” is used herein in connection with systems and computer program components. For a system of one or more computers to be configured to perform particular operations or actions means that the system has installed software, firmware, hardware, or a combination thereof that cause the system to perform the operations or actions. For one or more computer programs to be configured to perform operations or actions means that the one or more programs include instructions that, when executed by one or more data processing apparatus, cause the apparatus to perform the operations or actions.

The term “data processing apparatus” refers to data processing hardware and encompasses various apparatus, devices, and machines for processing data, including programmable processors, a computer, or combinations thereof. The data processing apparatus can include special purpose logic circuitry, such as a field programmable gate array (FPGA) or an application specific integrated circuit (ASIC), such as a Tensor Processing Unit (TPU). The data processing apparatus can include code that creates an execution environment for computer programs, such as code that constitutes processor firmware, a protocol stack, a database management system, an operating system, or combinations thereof.

The data processing apparatus can include special-purpose hardware accelerator units for implementing machine learning models to process common and compute-intensive parts of machine learning training or production, such as inference or workloads. Machine learning models can be implemented and deployed using one or more machine learning frameworks, such as static or dynamic computational graph frameworks.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a standalone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” can refer to a software-based system, subsystem, or process that is programmed to perform one or more specific functions. The engine can be implemented as one or more software modules or components or can be installed on one or more computers in one or more locations. A particular engine can have one or more processors or computing devices dedicated thereto, or multiple engines can be installed and running on the same processor or computing device. In some examples, an engine can be implemented as a specially configured circuit, while in other examples, an engine can be implemented in a combination of software and hardware.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers. While operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all examples, and it should be understood that the described program components and systems can be integrated together in one or more software or hardware-based devices or computer-readable media.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, desktop computer, a personal digital assistant (PDA), a mobile audio or video player, a game console, a tablet, a virtual-reality (VR) or augmented-reality (AR) device, a Global Positioning System (GPS), or a portable storage device, e.g., a universal serial bus (USB) flash drive, as examples. Examples of the computer or special purpose logic circuitry can include the user computing device 712, the server computing device 715, or the hardware accelerators 630.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, or combinations thereof.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible examples. Further, the same reference numbers in different drawings can identify the same or similar elements.

1. A method of pretraining a multimodal model, the method comprising:
receiving, by one or more processors, multimodal training data comprising un-masked training examples and masked training examples; and
performing, by the one or more processors, one or more pretraining iterations comprising:
generating modality-specific encoded representations of the un-masked training examples and masked training examples,
determining a plurality of modality-specific masking losses measuring the similarity between the modality-specific encoded representations of the un-masked training examples and the masked training examples.
generating a first fused encoded representation of the un-masked training example encoded representations and a second fused encoded representation of the masked training example encoded representations,
determining a multimodal masking loss measuring the similarity between the first fused encoded representation and the second fused encoded representation, and
updating, by the one or more processors, one or more weights of the multimodal model in accordance with both the plurality of modality-specific masking losses and the multimodal masking loss.

2. The method of claim 1, wherein the masked training examples comprise data that is least partially masked or removed from the un-masked training examples.

3. The method of claim 1, wherein the multimodal training data comprises data of a plurality of modalities, comprising structured data and at least one of text data, image data, video data, or audio data.

4. The method of claim 3, wherein the structured data comprises tabular feature data, time-series data, or both the tabular feature data and the time-series data.

5. The method of claim 4,
wherein generating the modality-specific encoded representations comprises generating, by the one or more processors, a structured data encoded representation using a structured data encoder of the multimodal model.

6. The method of claim 3, further comprising:
receiving, by the one or more processors, labeled training data comprising labeled training examples corresponding to a machine learning task; and
performing, by the one or more processors, one or more fine-tuning iterations of:
processing the labeled training data through the multimodal model,
determining a task-specific loss measuring performance of the multimodal model in performing the machine learning task, and
updating weights of the multimodal model in accordance with the task-specific loss.

7. The method of claim 6, further comprising:
after performing the one or more pretraining iterations and the one or more fine-tuning iterations, processing, by the one or more processors, instances of multimodal data input through the multimodal model to generate output in accordance with the machine learning task,
wherein:
one or more instances comprise data of each modality of the plurality of modalities present in the multimodal training data, and
each instance other than the one or more instances comprises different respective combinations of at least partially missing data of at least one modality of the plurality of modalities present in the multimodal training data.

8. The method of claim 1, wherein generating the first fused encoded representation and the second fused encoded representation comprises processing, by the one or more processors, the modality-specific encoded representations through a plurality of cross-attention layers of an attention-based transformer.

9. The method of claim 1, wherein the multimodal masking loss comprises:
a negative cosine similarity between a projection of the first fused encoded representation and the second fused representation, and
a negative cosine similarity between a projection of the second fused representation and the first fused encoded representation.

10. The method of claim 9, wherein updating the one or more weights comprises:
calculating a total loss as the sum of the plurality of modality-specific masking losses and the multimodal masking loss, each of the masking losses weighted by a respective hyperparameter value; and
updating the one or more weights of the multimodal model using backpropagation with gradient descent and the total loss.

11. A system, comprising:
one or more processors configured to:
receive multimodal input data;
process the multimodal input data through a multimodal model, pretrained in accordance with one or more total losses comprising:
a plurality of modality-specific masking losses from generating modality-specific encoded representations of masked and un-masked training examples, and
one or more multimodal masking losses from generating fused encoded representations of the modality-specific encoded representations; and
generate, in response to receiving the multimodal input data, model output from the multimodal model.

12. The system of claim 11, wherein:
a modality-specific masking loss is a measurement of the similarity between modality-specific encoded representations of the un-masked training examples and modality-specific encoded representations of the masked training examples, and
the one or more multimodal masking losses are measurements of similarities between fused encoded representations generated from modality-specific encoded representations for the masked training examples and fused encoded representations generated from modality-specific encoded representations for the un-masked training examples.

13. The system of claim 12, wherein the one or more processors are further configured to:
receive training data comprising the masked and un-masked training examples; and
perform one or more pretraining iterations, comprising:
generating the modality-specific encoded representations of the un-masked training examples and the masked training examples,
determining the plurality of modality-specific masking losses from the modality-specific encoded representations.
generating a first fused encoded representation of the un-masked training example encoded representations, and a second fused encoded representation of the masked training example encoded representations,
determining the multimodal masking loss from the first and the second fused encoded representations, and
updating, by the one or more processors, one or more weights of the multimodal model in accordance with both the plurality of modality-specific masking losses and the multimodal masking loss.

14. The system of claim 13, wherein in updating the one or more weights, the one or more processors are configured to:
determine the total loss as the sum of the plurality of modality-specific masking losses and the multimodal masking loss, each of the masking losses weighted by a respective hyperparameter value; and
update the one or more weights of the multimodal model using backpropagation with gradient descent and the total loss.

15. The system of claim 13, wherein the multimodal training data and the multimodal input data comprise data of a plurality of modalities, comprising structured data and at least one of text data, image data, video data, or audio data.

16. The system of claim 15, wherein the multimodal input data comprises:
one or more instances comprising data of each modality of the plurality of modalities present in the multimodal training data, and
each instance other than the one or more instances comprising different respective combinations of at least partially missing data corresponding to at least one modality of the plurality of modalities present in the multimodal training data.

17. The system of claim 11, wherein in generating the model output, the one or more processors are configured to:
receive labeled training data comprising labeled training examples corresponding to a machine learning task;
perform one or more fine-tuning iterations of:
processing the labeled training data through the multimodal model,
determining a task-specific loss measuring performance of the multimodal model in performing the machine learning task, and
updating one or more weights of the multimodal model in accordance with the task-specific loss.

18. One or more non-transitory computer-readable media encoding instructions that are operable, when performed by one or more processors, to cause the one or more processors to perform operations comprising:
receiving multimodal input data;
processing the multimodal input data through a multimodal model, pretrained in accordance with a total loss comprising:
a plurality of modality-specific masking losses from generating modality-specific encoded representations of masked and un-masked training examples, and
a multimodal masking loss from generating fused encoded representations of the modality-specific encoded representations; and
generating, in response to receiving the multimodal input data, model output from the multimodal model.

19. The computer-readable media of claim 18, wherein:
a modality-specific masking loss is a measurement of the similarity between modality-specific encoded representations of the un-masked training examples and modality-specific encoded representations of the masked training examples,
the multimodal masking loss is a measurement of the similarity between a first fused encoded representation and a second fused encoded representation of the fused encoded representations.

20. The computer-readable media of claim 19, wherein the operations further comprise:
receiving training data comprising the masked and un-masked training examples; and
performing one or more pretraining iterations, comprising:
generating the modality-specific encoded representations of the un-masked training examples and the masked training examples,
determining the plurality of modality-specific masking losses from the modality-specific encoded representations.
generating a first fused encoded representation of un-masked training example encoded representations, and a second fused encoded representation of masked training example encoded representations,
determining the multimodal masking loss from the first and the second fused encoded representations, and
updating one or more weights of the multimodal model in accordance with both the plurality of modality-specific masking losses and the multimodal masking loss.
